(19) United States
(12) Patent Application Publication
(10) Pub. No.: US 2026/0285240 A1
(43) Pub. Date: Sep. 24, 2026

(54) DISPLAY TILT MECHANISM

(71) Applicant: Tesla, Inc., Austin, TX (US)

(72) Inventors: Devan Maximo Wiitala, Hayward, CA (US); Raghav Jalan, San Francisco, CA (US); Brendan Kawar, Austin, TX (US); Alessandro Valenzuela Bernardis, Fremont, CA (US); Shakeel Theodore, Fremont, CA (US); Harold Mejia Ruiz, Lake Forest, CA (US)

(21) Appl. No.: 19/473,393

(22) PCT Filed: Apr. 17, 2024
(86) PCT No.: PCT/US2024/024896

§ 371 Date: Oct. 7, 2025

Related U.S. Application Data
(60) Provisional application No. 63/497,162, filed on Apr. 19, 2023.

(51) Int. Cl. B60R 11/02; B60K 35/22; B60K 35/53; B60R 11/00

(52) U.S. Cl. CPC B60R 11/0235; B60K 35/22; B60K 35/53; B60R 2011/0005; B60R 2011/0085; B60R 2011/0092

(57) ABSTRACT

A display assembly for deploying a display (104) includes a rail housing (220), a first link arm (214), a second link arm (214) and a motor transmission (216). During the deployment, the first link arm moves along a first rail formed by the rail housing at a first speed and the second link arm moves along a second rail formed by the rail housing at a second speed. The first speed is controlled to be different from the second speed such that the display may have less or minimized contact with a dashboard (102) of a vehicle during deployment.

### CROSS-REFERENCE TO RELATED APPLICATIONS

This application claims the benefit of U.S. Provisional Application No. 63/497,162, filed Apr. 19, 2023, the entire disclosure of which is hereby incorporated by reference in its entirety.

### TECHNICAL FIELD

The present disclosure relates to systems and methods for deploying a panel or a display. More particularly, some embodiments of the present disclosure relate to assemblies and mechanisms capable of tilting edges of a display of a vehicle.

### BACKGROUND

Displays and panels are becoming more prevalent in different aspects of life. For example, flat panel displays or monitors may be mounted on a wall of a house. As another example, an automotive display device may be installed in a dashboard portion of an automotive vehicle to facilitate interactions between the vehicle and drivers as well as passengers. To improve user experiences, it is desirable to adjust a position or orientation of the display to enable better viewing angles or ease of operations.

Different techniques have been developed to facilitate deployment of automotive displays. Some automotive displays may be supported by pop-up units such that the displays may emerge from dashboards through some movable mechanisms associated with the pop-up units. Once popped-up, drivers or passengers may adjust the positions or orientations of the automotive displays. Other designs utilize mounts or stands in coordination with movable arms for deployment. However, such designs may lose aesthetic appeal as unity of the interior design of vehicles is compromised by the mechanisms associated with deploying the displays. Additionally, the durability, reliability and repeatability of deploying displays are also of great importance but can be quite challenging to accomplish while maintaining the desired aesthetic look and feel associated with the interior of vehicles.

### SUMMARY

An aspect is directed to a display assembly for a vehicle. The display assembly comprises a rail housing, a first link arm, a second link arm and a motor transmission. The display assembly is capable of deploying a display initially positioned inside a recess of a dashboard of the vehicle without contacting or having minimized contact with the dashboard during deployment.

In some aspects, the techniques described herein relate to a display assembly for deployment of a display, wherein the display includes a first edge and a second edge both fitting with a dashboard of a vehicle while at an initial position, the display assembly including: a rail housing structurally forming a first rail and a second rail; a first link arm configured to connect to the display; a second link arm configured to connect to the display; and at least one motor transmission configured to drive the first link arm along the first rail and drive the second link arm along the second rail, wherein, during the deployment, the at least one motor transmission drives the first link arm along the first rail at a first speed and the second link arm along the second rail at a second speed different from the first speed such that the display does not interfere with the dashboard of the vehicle.

In some aspects, the techniques described herein relate to a display assembly, further including a center arm configured to attach to the display, wherein the rail housing further includes a center groove, and wherein the center arm is configured to move along the center groove during the deployment In some aspects, the techniques described herein relate to a display assembly, further including a center pin configured to fasten to the center arm, wherein a minimum distance between a center of the center pin and the rail housing is less than 0.15 mm.

In some aspects, the techniques described herein relate to a display assembly, wherein the center groove includes an outer edge that is configured to guide a movement of the center arm around the initial position.

In some aspects, the techniques described herein relate to a display assembly, wherein the display does not tilt toward the first edge nor toward the second edge at the initial position, and wherein the display tilts toward the second edge by 11 degrees during the deployment.

In some aspects, the techniques described herein relate to a display assembly, wherein the first link arm is closer to the first edge and the second link arm is closer to the second edge, and wherein the first speed is approximately twice the second speed.

In some aspects, the techniques described herein relate to a display assembly, wherein the first link arm is driven by a lead motor of the at least one motor transmission and the second link arm is driven by a follower motor of the at least one motor transmission, and wherein a speed of the follower motor is determined based on a speed of the lead motor.

In some aspects, the techniques described herein relate to a display assembly, wherein the second edge does not contact the dashboard during the deployment.

In some aspects, the techniques described herein relate to a display assembly, wherein a surface of the display facing a user and a surface of the dashboard facing the user are co-planar while the display is at the initial position.

In some aspects, the techniques described herein relate to an assembly for deployment of a display relative to a dashboard, the assembly including: a rail housing configured to couple to the dashboard, the rail housing including a groove; a left link arm configured to extend and retract a left side of the display relative to the rail housing; a right link arm configured to extend and retract a right side of the display relative to the rail housing; at least one motor coupled to at least one of the left link arm or the right link arm; and a center arm engaged with the groove and configured to guide movement of the display during the deployment.

In some aspects, the techniques described herein relate to an assembly, wherein the at least one motor includes a first motor and a second motor, wherein the first motor is configured to drive the left link arm to extend and retract the left side of the display, and wherein the second motor is configured to drive the right link arm to extend and retract the right side of the display.

In some aspects, the techniques described herein relate to an assembly, wherein the display tilts toward the left side by approximately 11 degrees when the right link arm extends the right side of the display to an upper limit.

In some aspects, the techniques described herein relate to an assembly, wherein the left link arm moves at a first speed and the right link arm moves at a second speed, and wherein the first speed is approximately twice or one-half of the second speed.

In some aspects, the techniques described herein relate to an assembly, wherein the rail housing includes a left rail and a right rail, wherein the left link arm moves along the left rail to extend and retract the left side of the display relative to the rail housing, and wherein the right link arm moves along the right rail to extend and retract the right side of the display relative to the rail housing.

In some aspects, the techniques described herein relate to an assembly, wherein the groove includes an outer edge that is configured to guide a movement of the center arm when the display is around a home position.

In some aspects, the techniques described herein relate to an assembly for deployment of a display having a first edge and a second edge fitting to a recess region of a structure while at a home position, the assembly including: a rail housing structurally forming a first rail and a second rail; a first link arm configured to connect to the display; and a second link arm configured to connect to the display, wherein the first link arm is driven by at least one motor transmission along the first rail at a first speed and the second link arm is driven by the at least one motor transmission along the second rail at a second speed different from the first speed such that the display does not interfere with the structure during the deployment.

In some aspects, the techniques described herein relate to an assembly, further including a center arm configured to attach to the display, wherein the rail housing includes a groove, and wherein the center arm is configured to move along the groove during the deployment.

In some aspects, the techniques described herein relate to an assembly, wherein the groove includes an outer edge that is configured to guide a movement of the center arm around the home position.

In some aspects, the techniques described herein relate to an assembly, wherein the display does not tilt toward the first edge nor toward the second edge at the home position, and wherein the display tilts toward the second edge during the deployment.

In some aspects, the techniques described herein relate to an assembly, wherein the first link arm is closer to the first edge and the second link arm is closer to the second edge, and wherein the first speed is approximately twice the second speed.

### BRIEF DESCRIPTION OF THE DRAWINGS

Embodiments of the present disclosure are described with reference to the accompanying drawings, in which like reference characters reference like elements, and wherein:

FIG. 1 illustrates a front perspective view of an example integration of a dashboard with certain parts removed, a display, and a display assembly according to some embodiments of the present disclosure.

FIG. 2 depicts a bottom view of an example integration of a display assembly and the dashboard of FIG. 1 in accordance with some embodiments of the present disclosure.

FIG. 3 illustrates a side view showing an example deployment of the display of FIG. 1 through movements of various components of the display assembly of FIG. 2 in accordance with some embodiments of the present disclosure.

FIG. 4 illustrates a side perspective view showing an example deployment of the display of FIG. 1 through movements of various components of the display assembly of FIG. 2 in accordance with some embodiments of the present disclosure.

FIG. 5 depicts a top view showing an example deployment of the display of FIG. 1 through movements of various components of the display assembly of FIG. 2 in accordance with some embodiments of the present disclosure.

FIG. 6 illustrates a bottom view showing an example deployment of the display of FIG. 1 through movements of various components of the display assembly of FIG. 2 in accordance with some embodiments of the present disclosure.

FIG. 7 illustrates expanded views showing portions of a display assembly, such as the display assembly of FIG. 2, in accordance with some embodiments of the present disclosure.

FIG. 8 illustrates a section side view of the portions of the display assembly of FIG. 7 and with certain parts removed to reveal some internal structures of the display assembly in accordance with some embodiments of the present disclosure.

FIG. 9 illustrates an exploded view of the portions of the display assembly of FIG. 7 in accordance with some embodiments of the present disclosure.

FIG. 10 illustrates top perspective views of an example integration of portions of a display assembly of FIG. 7 and a solar display panel according to some embodiments of the present disclosure.

FIG. 11 illustrates a front perspective view of an example integration of the display assembly, the display, and the dashboard of FIG. 1 in accordance with some embodiments of the present disclosure.

FIG. 12 illustrates a top perspective view of an example integration of the display assembly and the dashboard of FIG. 1 in accordance with some embodiments of the present disclosure.

### DETAILED DESCRIPTION

Generally described, one or more aspects of the present disclosure correspond to systems and methods that use motor transmissions and mechanical structures to control deployment of panels or displays. More specifically, some embodiments of the present disclosure disclose mechanisms and assemblies that are capable of tilting edges of a display by driving two motor-driven arms attached to a backside of a display panel in different degrees. In some embodiments, a center arm may be further attached to the backside of the display panel to guide movements of the two motor-driven arms as well as the display panel. Advantageously, the coordination among the center arm and two motor-driven arms can enable the display panel to be symmetrically tilted toward the driver side and passenger side of a vehicle from an initial position (e.g., a “home” position) at which the display panel may fit almost seamlessly with a dashboard of the vehicle. As such, the unity of the interior design around the dashboard of the vehicle can be preserved while allowing drivers and passengers to more easily interact with the vehicle through the deployment of the display.

Additionally, the disclosed systems and methods further implement techniques to increase repeatability or predictability of deployment of the display, maintain durability or sustainability of associated mechanical components and protect the instrument panel (IP) trim environment during deployment of the display. In some embodiments, mechanically-tuned structures are utilized to guide movements of the center arm attached to the display such that the display can return to the “home” position with precision repeatedly. Further, the mechanically-tuned structures may be designed with a shape and size that properly constrains movements of the arms attached to the display to avoid damage to or binding with the dashboard during deployment of the display. In some embodiments, dimensions of parts of the display deployment assemblies are designed to increase system repeatability, durability or sustainability. For example, the distance between the center arm and a groove structure on which the center arm can move back and forth to deploy the display may be selected to be within a suitable distance such that the center arm is neither tightly constrained by the groove structure to lose durability resulted from wear of components nor loosely constrained by the groove structure to lose repeatability or reliability.

Typically, vehicles include displays or screens in front of operators and/or passengers. Some vehicles provide movable or deployable displays around the dashboard to improve interactions with users. To enable positional adjustments of the display, some automotive systems conceal the display in the dashboard using an opening that is closed when the display is not in use. When in use, the opening can be cleared before the display is moved out from the dashboard. Such approach may be less user-friendly as the opening has to be cleared before the user can operate on the display. Other designs utilize mounts or stands in coordination with movable arms for deployment. Such designs, however, may make the interior of the vehicle less visually pleasing or occupy additional spaces around the driver or front passenger seats, thereby leading to an inferior user experience.

To enhance user experience, a dashboard display may be designed to fit seamlessly with the dashboard while being easily accessible and positionally customizable by a user. For example, at an initial or “home” position, the display may be positioned in a recess area of the dashboard. When in the home position, an edge of the display can form a flush-fit with the dashboard. Then, depending on whether a driver or a passenger intends to access the display, the display can tilt toward the driver or the passenger. However, it can be challenging for this kind of design to function with reliability and durability. As the edge of the display is closely fit to the dashboard, straightforward mechanisms for moving the display may damage the dashboard or the display. Further, to accomplish repeatable and reliable operation of the display deployment assemblies, components or mechanical parts of the assemblies may have to be properly or, in some instances, tightly constrained. Yet, excessive constraints can lead to wear of the mechanical components, resulting in a shorter operation lifetime.

To address at least a portion of the above problems, display assemblies are disclosed in accordance with some embodiments of the present disclosure. In some embodiments, a display assembly can allow a display to fit almost seamlessly into a recess of a dashboard of a vehicle when the display assembly is at an initial or a home position. In some embodiments, at the home position, the surface of the display may fit flush relative to the dashboard. For example, in certain embodiments, the surface of the display is co-planar with the surface of the dashboard. In some embodiments, the backside of the display may be connected with two link arms of the display assembly and each of the link arms may be driven by a respective motor. In some embodiments, one of the motors may rotate faster than the other to drive a respective link arm at a higher speed such that the display may tilt toward one of the right edge and the left edge. In some embodiments, during deployment of the display, the relative speeds of the link arms are controlled such that the left edge or the right edge may have minimized contact or interference with the dashboard of the vehicle. In some embodiments, one link arm moves at approximately twice the speed of the other link arm. In some embodiments, one of the motors (e.g., the lead motor) may travel at a first velocity (e.g., a programmable velocity or a programmed velocity) that is controllable by a microcontroller or a processor. Additionally, the other of the motors (e.g., the follower motor) may travel at a second velocity that is approximately half of the first velocity.

In some embodiments, the display assembly may further include a center arm configured to move along a groove structurally formed by a rail housing. In some embodiments, the groove has an outer edge that is designed to guide the movement of the center arm around the home position such that the center arm may return to a same precise position during each operation. In some embodiments, one end of the center arm is fastened to a center pin. In some embodiments, while at the home position, a clearance distance exists from the center of the center pin to the closest point on the rail housing. In some embodiments, the clearance distance is less than 0.15 mm. In some embodiments, the groove is designed to have a shape (e.g., a shape like the alphabet “V”) to reduce or minimize contact between the display and the dashboard as the link arms are extending away from the home position. Advantageously, with the center pin fastened to the center arm, the deployment of the display assembly may be constrained to prevent or reduce wear of the display assembly.

Although the various aspects will be described in accordance with illustrative embodiments and combination of features, one skilled in the relevant art will appreciate that the examples and combination of features are illustrative in nature and should not be construed as limiting. More specifically, aspects of the present application may be applicable with various types of displays, monitors, panels under different contexts, such as when attached to a wall of a building room, a roof of a building or a surface of a vehicle. Still further, although specific architectures of display interfaces or assemblies for tilting edges of a display will be described, such illustrative display interfaces or assemblies design or architecture should not be construed as limiting. Accordingly, one skilled in the relevant art will appreciate that the aspects of the present application are not necessarily limited to application to any particular types of display assemblies, display assemblies infrastructure or illustrative interactions between drivers/passengers and dashboard displays of vehicles.

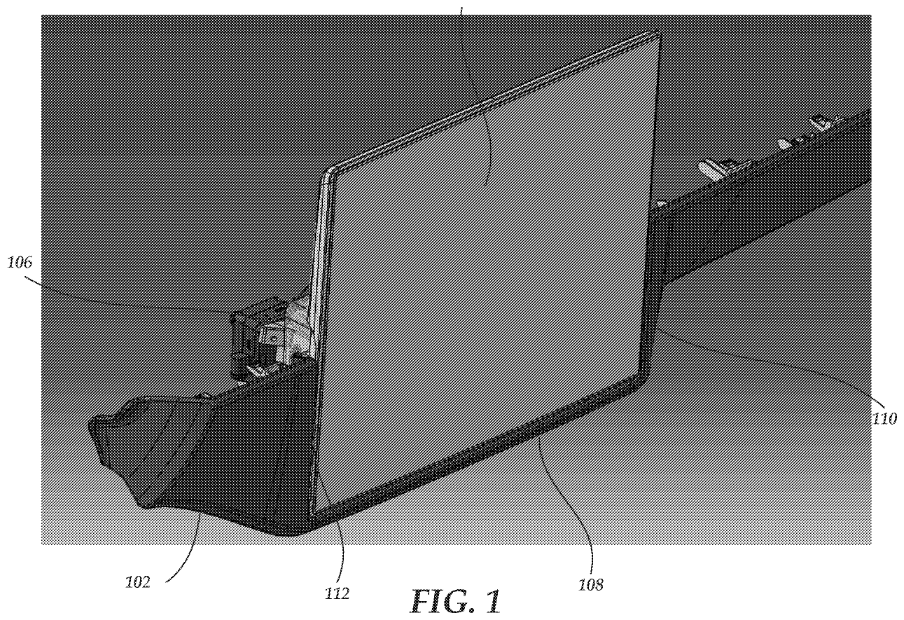

FIG. 1 illustrates a front perspective view of an example integration of a dashboard 102 with certain parts removed, a display 104 and a display assembly 106 according to some embodiments of the present disclosure. As shown in FIG. 1, the edge 108, edge 110, and edge 112 of the display 104 are fit to the dashboard 102. More specifically, a recess region is provided in the dashboard 102 so as to accommodate the display 104 and the display assembly 106. FIG. 1 depicts the display 104 and the display assembly 106 in an initial or a home position, where the edge 108, edge 110, and edge 112 of the display 104 may be fit along the recess region of the dashboard 102. In some embodiments, at the home position, the surface of the display 104 may be coplanar with the surface of the dashboard 102. In some embodiments, the edge 108, edge 110, and edge 112 of the display 104 form a flush fit with the surface of the dashboard 102 when in the home position.

In some embodiments, the dashboard 102 may be integrated as a part of a vehicle (not shown in FIG. 1). Vehicles may include automobiles, vans, trucks, maritime vessels, aircraft, or spacecraft. Although not illustrated in FIG. 1, in some embodiments, the display assembly 106 may be attached to other interfaces, such as walls of a building room, a roof of a building or other surfaces unto which panels or displays may be installed.

As will be discussed below, in some embodiments, the display assembly 106 may cause the display 104 to tilt horizontally toward the edge 110 or the edge 112 of the display 104. In some embodiments, a user may trigger the tilting toward the edge 110 or the edge 112 of the display 104 by interacting with a user interface on the display 104. In some embodiments, the display assembly 106 controls deployment of the edge tilting of the display 104 such that the edge 110 and the edge 112 of the display 104 may not contact or bind with parts of the dashboard 102 even when the display 104 does not move out in a direction vertical to the surface of the dashboard 102 before the deployment of the edge tilting begins.

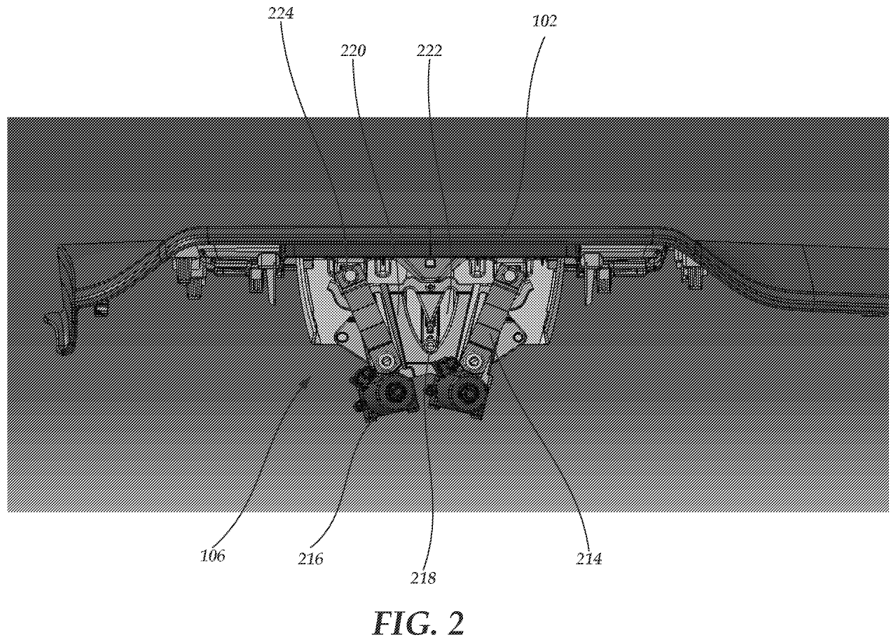

FIG. 2 depicts a bottom perspective of an example integration of the display assembly 106 and the dashboard 102 of FIG. 1 in accordance with some embodiments of the present disclosure. As shown in FIG. 2, the display assembly 106 includes various components, such as the motor transmissions 216, link arms 214, the center pin 218, and the rail housing 220. In some embodiments, the center pin 218 may be a shaft, a forged pin or the like. FIG. 2 depicts the display assembly 106 in the home position, where the center pin 218 is positioned at the center point of a groove 222 of the rail housing 220. As illustrated in FIG. 2, the groove 222 bears a V-shape. However, it should be noted that other shapes may be applicable to the groove 222 and should not be construed to fall outside the scope of the present disclosure.

As illustrated in FIG. 2, there are two pairs of link arms 214 and motor transmission 216. Although not easily observed from FIG. 2, both link arms 214 may connect to a backside of the display 104 through some fastener components 224 to control deployment of the display 104. In some embodiments, both motor transmissions 216 may drive corresponding link arms 214 simultaneously when deploying the display 104 toward the edge 110 or the edge 112. Depending on which edge to tilt toward, one of the motor transmission 216 may drive or rotate faster than the other motor transmission 216 such that one of the link arms 214 can extend more than the other link arm 214 to tilt towards the edge 110 or the edge 112 of the display 104. In some embodiments, the speed with which one of the link arms 214 extends may be about twice the speed with which the other of the link arms 214 extends such that the edge 110 or the edge 112 of the display 104 does not interfere with the dashboard 102 during deployment of the display 104.

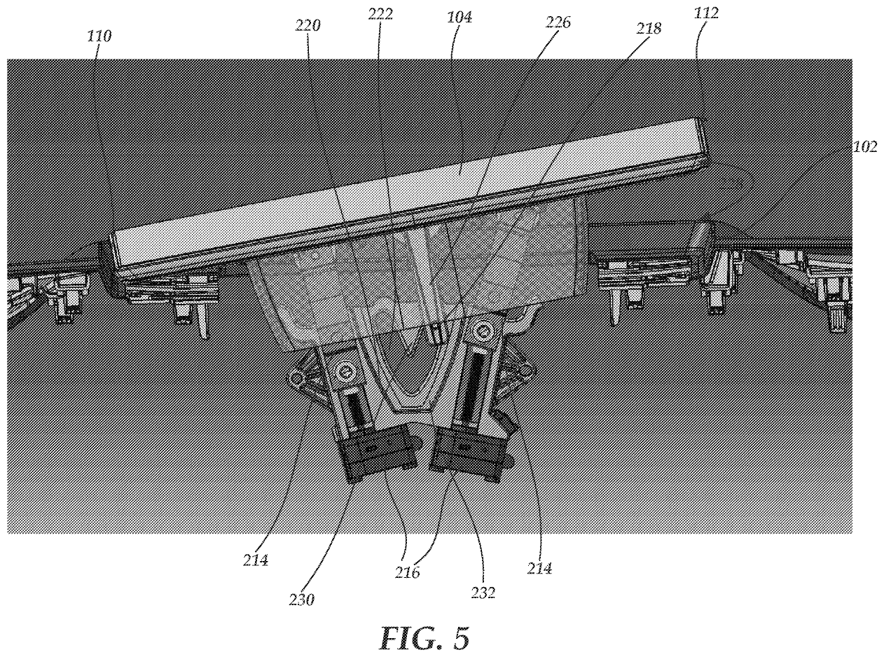

In some embodiments, the center pin 218 may be connected with a center arm (not shown in FIG. 2 but shown in FIG. 5), where an end of the center arm is connected to the backside of the display 104. In some embodiments, the center arm may guide or properly constrain the deployment of the display 104 when the link arms 214 extend forward and backward under different speeds to achieve reliable and repeatable operations of deploying the display 104.

In some embodiments, the rail housing 220 and the center pin 218 may have a clearance distance when the center pin 218 is at the home position as illustrated in FIG. 2. More specifically, there may be a gap between the central part of the center pin 218 to the portion of the rail housing 220 that is around the bottom end of the groove 222. In some embodiments, the gap may be designed to be below a predefined distance. When the gap is above the predefined distance, the deployment of the display 104 may be less repeatable as the display assembly 106 and the display 104 return back to the home position as illustrated in FIG. 2. This is because an excessive gap may lead to loosely constrained movements around the home position and the display 104 or the display assembly 106 may settle at different positions around the home position for different operations. On the other hand, the display assembly 106 may be overly constrained without the clearance distance or the gap. In some embodiments, the gap between the central part of the center pin 218 to the portion of the rail housing 220 that is around the bottom end of the groove 222 may be designed to be no more than 0.15 millimeter (mm) to achieve the desired constraints.

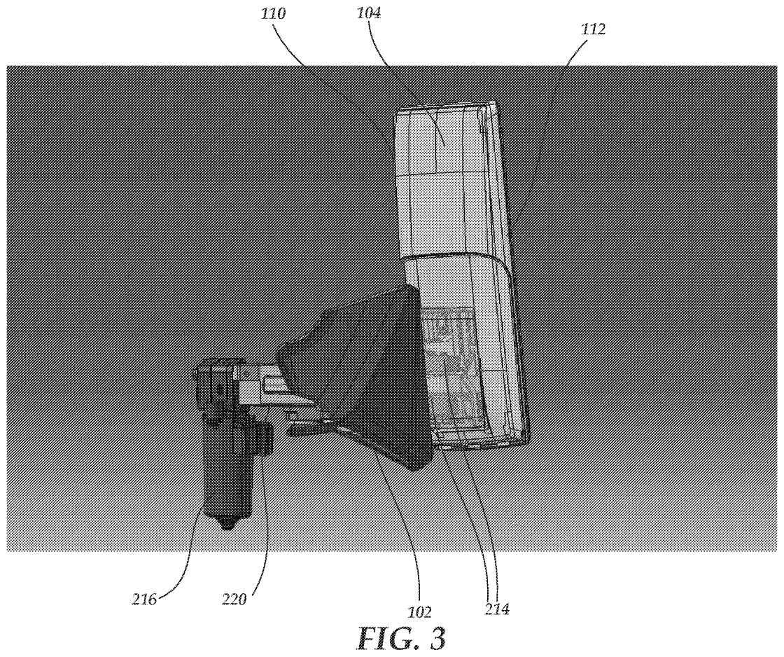

FIG. 3 illustrates a side view showing an example deployment of the display 104 through movements of various components of the display assembly 106 of FIG. 2 in accordance with some embodiments of the present disclosure. As illustrated in FIG. 3, one of the link arms 214 (shown in FIG. 3) may be driven by the motor transmission 216 to extend more than the other link arm 214 (not shown in FIG. 3). As such, the display 104 may tilt toward the edge 110 as the edge 112 of the display 104 moves further away from the dashboard 102.

As illustrated in FIG. 3, one of the link arms 214 may have an upper portion and a lower portion to sandwich the rail housing 220 in between. It should be noted that, in some embodiments, one link arm 214 may only need an upper portion or a lower portion or have a different form factor.

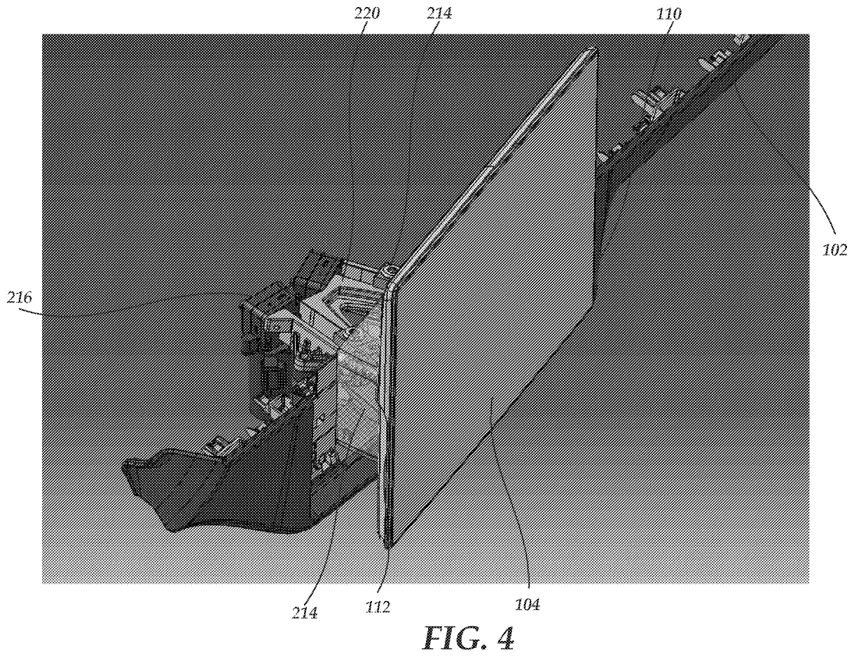

FIG. 4 illustrates a side perspective view showing an example deployment of the display 104 through movements of various components of the display assembly 106 of FIG. 2 in accordance with some embodiments of the present disclosure. As shown in FIG. 4, the display 104 is deployed to horizontally (with respect to a ground of a vehicle associated with the dashboard 102) tilt toward the edge 110 of the display 104. As illustrated in FIG. 4, such deployment results from the movements of both link arms 214 driven by respective motor transmission 216. More specifically, the link arm 214 closer to the edge 112 of the display 104 moves away from the home position more than the link arm 214 closer to the edge 110 of the display 104, thereby causing the display 104 to be tilted toward the edge 110 of the display 104

As shown in FIG. 4, in some embodiments, the edge 110 maintains a close fit with the dashboard 102 during deployment from the home position to the position illustrated in FIG. 4 without impacting or binding against the dashboard. Maintaining the close fit between the edge 110 of the display 104 and the dashboard 102 during deployment without the edge 110 interfering with the dashboard 102 may be attributed to the relative speeds associated with both link arms 214 and the design of the groove 222 that help guide the movements of the display 104 as discussed above.

FIG. 5 depicts a top perspective view showing an example deployment of the display 104 through movements of various components of the display assembly 106 of FIG. 2 in accordance with some embodiments of the present disclosure. As shown in FIG. 5, the display 104 is tilted toward the edge 110 because of the different movements associated with the link arms 214. The specific movements of the link arms 214 is caused by the different motions associated with the respective motor transmission 216.

As illustrated in FIG. 5, one of the link arms 214 may have extended to the limit while the other link arms 214 may have extended only half of the limit. As such, FIG. 5 may illustrate the largest degree 228 the display 104 may tilt horizontally toward the edge 110. In some embodiments, the largest degree 228 with which the display 104 may tilt is 11 degrees. In some embodiments, the center arm 226 may be utilized to help guide the movement of the display assembly 106 during the deployment of the display 104 to achieve repeatable operations while prevent wearing or damage of components.

As shown in FIG. 5, in some embodiments, the rail housing 220 includes a portion 230 that is tapering toward the center of the rail housing 220. Such shape of the portion 230 can help guide the movement of the display 104 during deployment, thereby preventing impact or damage associated with interference between the edge 110 of the display 104 and the dashboard 102. Specifically, as the link arm 214 located closer to the edge 112 extends faster from the home position than the link arm 214 closer to the edge 110 during deployment, the portion 230 may help guide the movements of the center arm 226. As such, the edge 110 of the display 104 may avoid impacting or damaging the adjacent portion of the dashboard 102. In some embodiments, the edge 110 may maintain a close fit to the adjacent part of the dashboard 102 throughout the deployment of the display 104.

As illustrated in FIG. 5, the rail housing 220 includes an outer edge 232 around the groove 222. In operations, the outer edge 232 can guide movements of the display assembly 106 as the display 104 moves toward and away from the home position. Specifically, as the center arm 226 moves from the position illustrated in FIG. 5 to approach the home position, the outer edge 232 may guide the movement of the center arm 226 to follow an adequately constrained path. Thus, the movements of the display 104 approaching the home position may be repeatable or consistent throughout multiple deployment of the display 104 at different times. Advantageously, the design of the outer edge 232 can enable the display assembly 106 to precisely return to the home position, thereby allowing the display 104 to almost seamlessly fit with the dashboard 102 while at the home position.

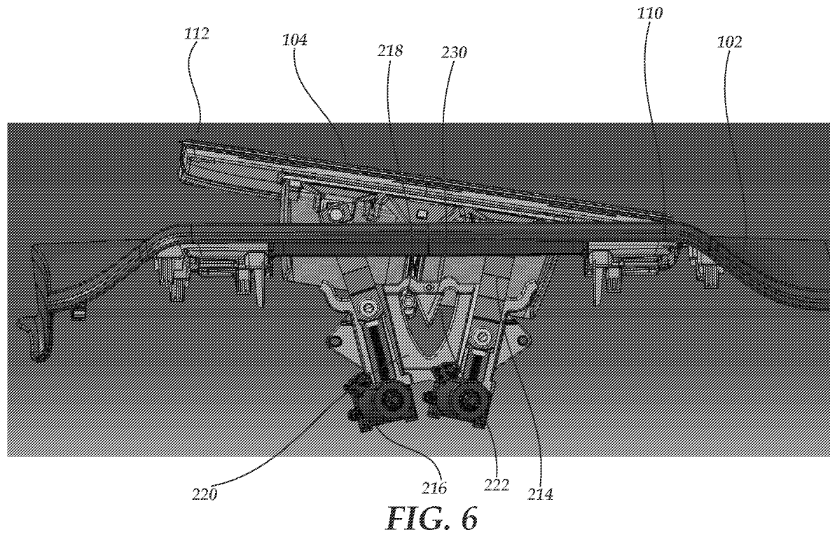

FIG. 6 illustrates a bottom perspective view showing an example deployment of the display 104 of FIG. 1 through movements of various components of the display assembly 106 of FIG. 2 in accordance with some embodiments of the present disclosure. As shown in FIG. 6, while both link arms 214 move away from the home position, one of the link arms 214 (e.g., the link arm 214 closer to the edge 112) extend more than the other of the link arms (e.g., the link arm 214 closer to the edge 110), resulting in the display 104 horizontally tilting toward the edge 110 of the display 104. In some embodiments, during the deployment of the display 104, the edge 110 may maintain its close fit with the adjacent part of the dashboard 102.

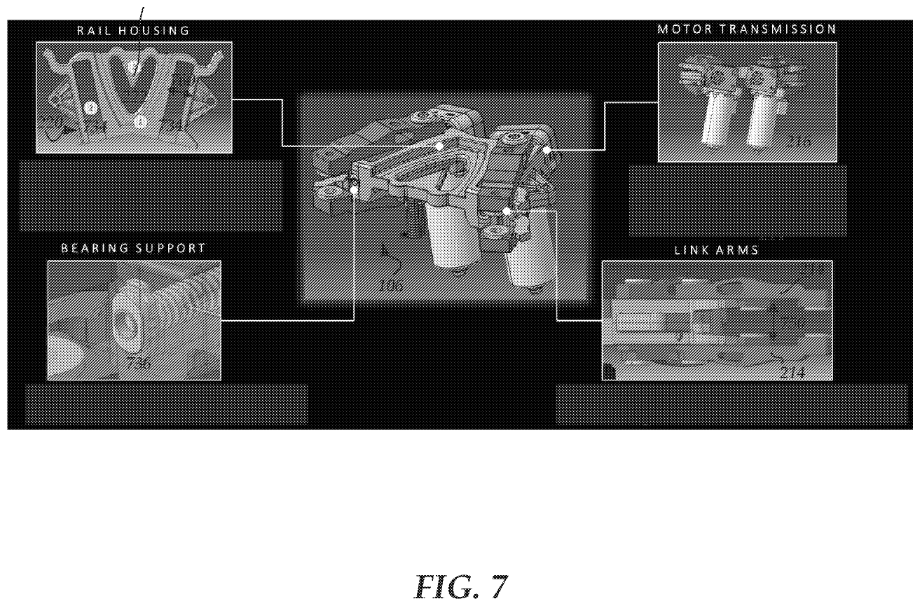

FIG. 7 illustrates expanded views showing portions of a display assembly (referred to as the display assembly 106) in accordance with some embodiments of the present disclosure. The display assembly 106 of FIG. 7 may be the same or similar to the display assembly 106 of FIG. 2. As such, components in the display assembly 106 of FIG. 7 may function or operate the same or similar to the corresponding components of the display assembly 106 of FIG. 2. As shown in FIG. 7, the display assembly 106 may include a rail housing 220, the motor transmission 216, the link arms 214. The rail housing 220 may be designed to have the groove 222 and two rails 734. In some embodiments, each of the rails 734 allows one of the link arms 214 to move back and forth along the rail 734 to deploy the display 104.

As illustrated in FIG. 7, in some embodiments, the groove 222 may be designed to bear a particular shape (e.g., a V-shape) and size to properly constrain movements of the link arms 214 at or around the “home” position to ensure repeatability or reliability of motion. The portion 230 may be designed to taper toward the center of the rail housing 220 for protecting the instrument panel (IP) from the trimming environment during deployment. Widths 760 of the two rails 734 may be designed to avoid wear of rail nut 740. For example, the widths 760 of the two rails 734 may be at or around 13 millimeters (mm), 13.5 mm, 14.0 mm, 14.5 mm, 15.0 mm, 15.5 mm, 16.0 mm, 16.5 mm, 17.0 mm, 17.5 mm, 18.0 mm, or any ranges of values therebetween.

In some embodiments, the length of the rails 734 may be designed to be 50 millimeters (mm). In some embodiments, the length of the rails 734 may be larger or smaller than 50 mm. In some embodiments, the motor transmission 216 can be controlled by firmware and/or a microcontroller associated with the display assembly to cause the link arms 214 to move along the rail 734 at a desired speed. In some embodiments, the motor transmission 216 can cause the link arms 214 to move at about the speed of 12.5 mm per second. In some embodiments, the motor transmission 216 can be controlled by the firmware to limit the maximum distance the link arms 214 may move away from the home position to constrain movements of the display 104. In some embodiments, the maximum distance the link arms 214 may move away from the home position may be 49 mm, smaller than the length of the rail 734. In some embodiments, one of the link arms 214 can be driven by the motor transmission 216 to move at a speed of approximately 12.5 mm per second while the other of the link arms 214 can be driven by the motor transmission 216 to move at a speed around 6.25 mm per second. In some embodiments, the link arms 214 can be driven by the motor transmission 216 to move at speeds lower than or higher than 12.5 mm per second. In some embodiments, the motor transmission 216 may employ two parallel motors for increasing or maximizing electrical current signal fidelity for transmission. In some embodiments, bushing spacing 750 in the link arms 214 may be machined to be around 4.20 mm, 4.25 mm, 4.30 mm, 4.35 mm, 4.40 mm, or any ranges of values therebetween to achieve parallelism associated with the link arms 214 during repeatedly deployment.

In some embodiments, the rail housing 220 may have a bearing support 736 at one end. In some embodiments, the bearing support 736 may be low carbon steel and may be lubricated. Advantageously, the bearing support 736 may help limit or prevent wear of a spindle (not shown in FIG. 7) caused by movement of the link arms 214. In some embodiments, the link arms 214 may be coated with PTFE (Polytetrafluoroethylene) to facilitate smooth movements of the link arms 214 along the rail 734. A thickness of the PTFE coating may be between 0.03 mm to 0.06 mm, or any ranges of values therebetween.

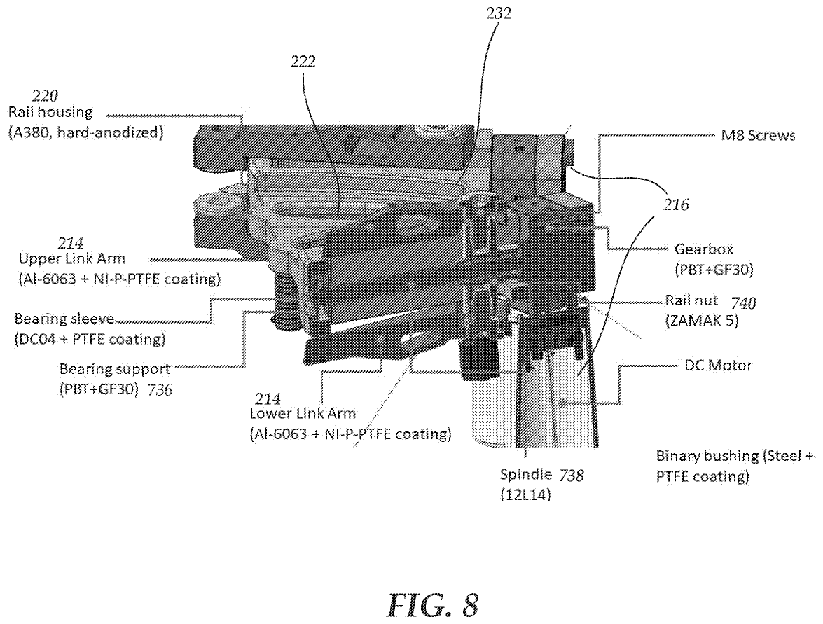

FIG. 8 illustrates a partial cross-section view of portions of the display assembly 106 of FIG. 7 and with certain parts removed to reveal some internal structures of the display assembly 106 of FIG. 7 in accordance with some embodiments of the present disclosure. FIG. 8 shows parts of the motor transmission 216, including the gearbox and the DC motor. FIG. 8 further shows the groove 222 and the outer edge 232 of the rail housing 220. As the motor transmission 216 operates, the spindle 738 rotates as well, causing the movement of the rail nut 740 along the rail 734, thereby moving the link arms 214 back and forth along the rail 734. In some embodiments, the width of the rail 734 is designed to be around 16.3 mm to avoid the wearing of the rail nut 740.

In some embodiments, the rail housing 220 is made of metallic material such as aluminum and is hard-anodized. In some embodiments, the center pin 218 is a forged pin made of metallic material such as steel. In some embodiments, the materials for making the rail housing 220 and the center pin 218 are selected such that the center pin 218 may be less stiff than the rail housing 220. Advantageously, such selections of the materials for making the rail housing 220 and the center pin 218 can help achieve durability and smooth operation of the display assembly 106.

In some embodiments, the link arms 214 include an upper part (e.g., upper link arm) and a lower part (e.g., lower link arm), where the link arms 214 may be made of metallic material such as aluminum. In these embodiments, the material for making the link arms 214 may provide sufficient stiffness to achieve sustainability and durability of the link arms 214 as the link arms 214 withstand forces on the order of thousands of Newtons when moving back and forth along the rail 734 without comprising the smoothness of the movements of the link arms 214.

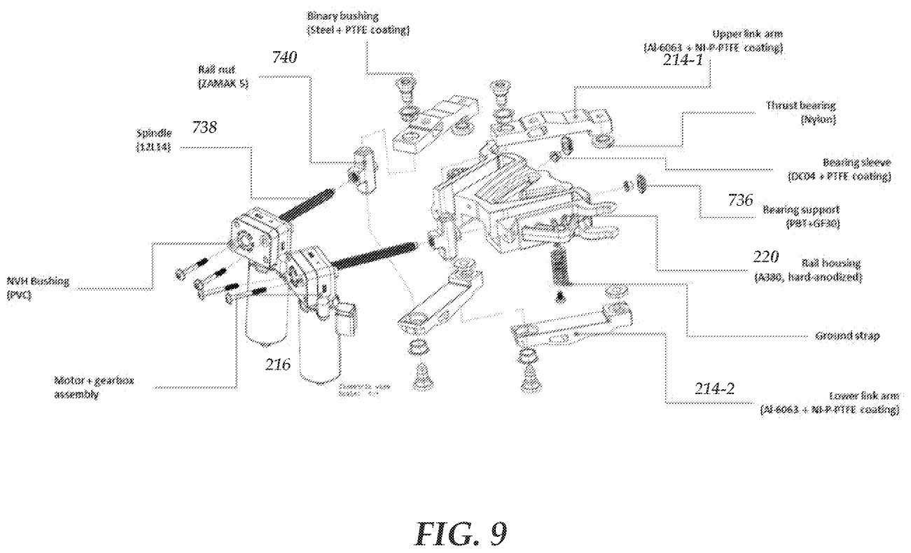

FIG. 9 illustrates an exploded view of portions of the display assembly 106 of FIG. 7 in accordance with some embodiments of the present disclosure. FIG. 9 shows the display assembly 106 includes at least the motor transmission 216, including a gearbox and motor assembly, the spindle 738, the rail nut 740, an upper link arm 214-1, a lower link arm 214-2, the bearing support 736, and the rail housing 220.

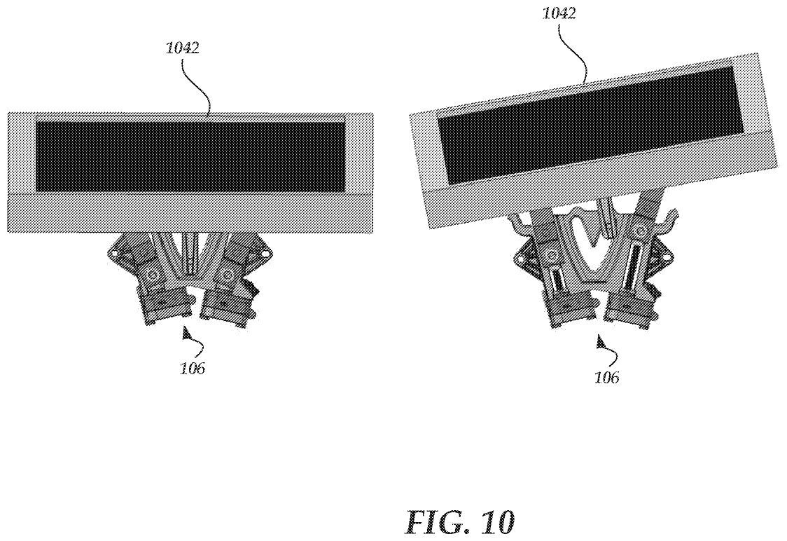

FIG. 10 illustrates top perspective views of an example integration of portions of a display assembly 106 of FIG. 7 and a solar display panel 1042 according to some embodiments of the present disclosure. Besides being utilized to tilt the display 104 as illustrated in FIGS. 1-6, the display assembly 106 can be utilized to tilt the solar display panel 1042 as shown in FIG. 10. Although not illustrated in FIG. 10, the display assembly 106 may be employed to deploy a flat panel display, a television monitor or the like attached to a wall of a building room or attached in under other background settings.

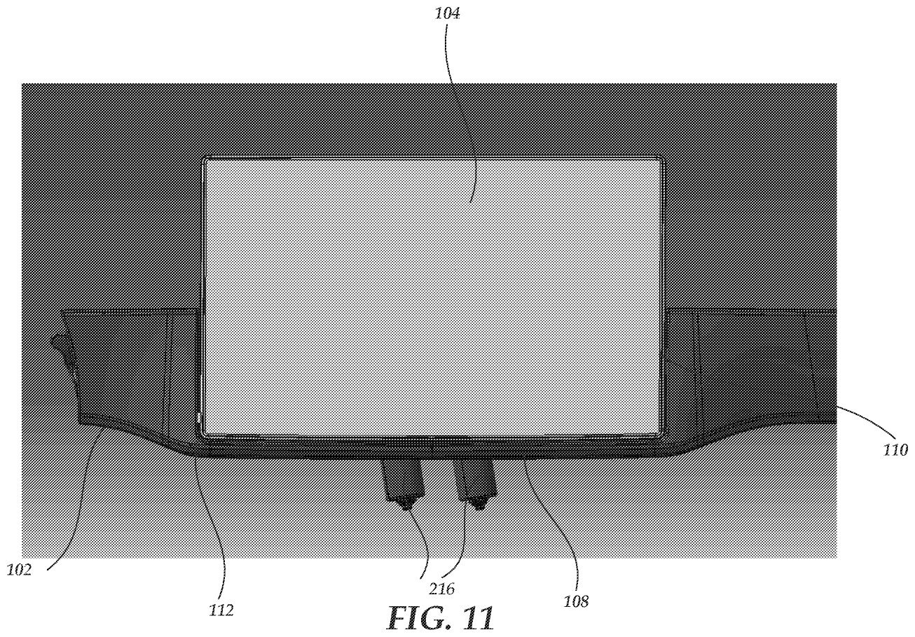

FIG. 11 illustrates a front perspective view of an example integration of the display assembly 106 (only the motor transmissions 216 of the display assembly 106 are shown), the display 104, and the dashboard 102 of FIG. I according to some embodiments of the present disclosure. As shown in FIG. 11, the edge 108, edge 110, and edge 112 of the display 104 fit to the dashboard 102. More specifically, a recess region is provided in the dashboard 102 so as to accommodate the display 104. FIG. 1 depicts the display 104 in an initial or a home position, where the edge 108, the edge 110, and the edge 112 of the display 104 may be fit along the recess region of the dashboard 102. In some embodiments, at the home position, the surface of the display 104 may be coplanar with the surface of the dashboard 102. In some embodiments, the edge 108, the edge 110, and the edge 112 of the display 104 form a flush fit with the surface of the dashboard 102 when in the home position.

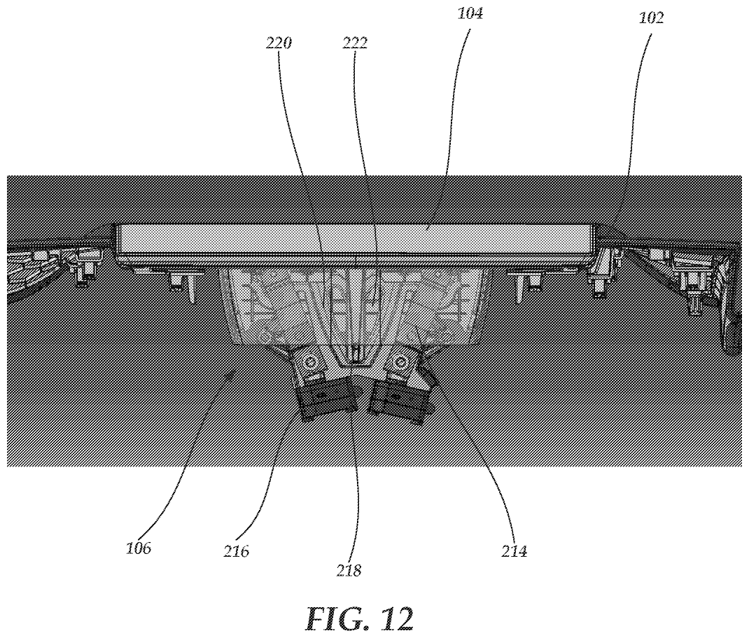

FIG. 12 illustrates a top perspective view of an example integration of the display assembly 106, the display 104, and the dashboard 102 of FIG. 1 in accordance with some embodiments of the present disclosure. FIG. 12 depicts the display 104 in the initial or the home position. FIG. 12 shows various parts of the display assembly 106, such as the motor transmission 216, the center pin 218, the link arms 214 (e.g., upper link arms), the groove 222, and the rail housing 220.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosed display assemblies.

It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural. Further, various embodiments disclosed herein are to be taken in the illustrative and explanatory sense, and should in no way be construed as limiting of the present disclosure.

All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other. Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

The illustrative algorithms described in connection with the embodiments disclosed herein can be implemented as electronic hardware (e.g., ASICs or FPGA devices), computer software that runs on computer hardware, or combinations of both. Moreover, the various illustrative logical blocks and modules described in connection with the embodiments disclosed herein can be implemented or performed by a machine, such as a processor device, a digital signal processor (“DSP”), an application specific integrated circuit (“ASIC”), a field programmable gate array (“FPGA”) or other programmable logic device, discrete gate or transistor logic, discrete hardware components, or any combination thereof designed to perform the functions described herein. A processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the rendering techniques described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

It will also be appreciated that one or more of the elements depicted in the drawings/figures can also be implemented in a more separated or integrated manner, or even removed or rendered as inoperable in certain cases, as is useful in accordance with a particular application.

What is claimed is:

1. A display assembly for deployment of a display, wherein the display includes a first edge and a second edge both fitting with a dashboard of a vehicle while at an initial position, the display assembly comprising:
a rail housing structurally forming a first rail and a second rail;
a first link arm configured to connect to the display;
a second link arm configured to connect to the display; and
at least one motor transmission configured to drive the first link arm along the first rail and drive the second link arm along the second rail,
wherein, during the deployment, the at least one motor transmission drives the first link arm along the first rail at a first speed and the second link arm along the second rail at a second speed different from the first speed such that the display does not interfere with the dashboard of the vehicle.

2. The display assembly of claim 1, further comprising a center arm configured to attach to the display, wherein the rail housing further comprises a center groove, and wherein the center arm is configured to move along the center groove during the deployment.

3. The display assembly of claim 2, further comprising a center pin configured to fasten to the center arm, wherein a minimum distance between a center of the center pin and the rail housing is less than 0.15 mm.

4. The display assembly of claim 2, wherein the center groove comprises an outer edge that is configured to guide a movement of the center arm around the initial position.

5. The display assembly of claim 1, wherein the display does not tilt toward the first edge nor toward the second edge at the initial position, and wherein the display tilts toward the second edge by 11 degrees during the deployment.

6. The display assembly of claim 5, wherein the first link arm is closer to the first edge and the second link arm is closer to the second edge, and wherein the first speed is approximately twice the second speed.

7. The display assembly of claim 6, wherein the first link arm is driven by a lead motor of the at least one motor transmission and the second link arm is driven by a follower motor of the at least one motor transmission, and wherein a speed of the follower motor is determined based on a speed of the lead motor.

8. The display assembly of claim 1, wherein the second edge does not contact the dashboard during the deployment.

9. The display assembly of claim 1, wherein a surface of the display facing a user and a surface of the dashboard facing the user are co-planar while the display is at the initial position.

10. An assembly for deployment of a display relative to a dashboard, the assembly comprising:
a rail housing configured to couple to the dashboard, the rail housing comprising a groove;
a left link arm configured to extend and retract a left side of the display relative to the rail housing;
a right link arm configured to extend and retract a right side of the display relative to the rail housing;
at least one motor coupled to at least one of the left link arm or the right link arm; and
a center arm engaged with the groove and configured to guide the movement of the display during the deployment.

11. The assembly of claim 10, wherein the at least one motor comprises a first motor and a second motor, wherein the first motor is configured to drive the left link arm to extend and retract the left side of the display, and wherein the second motor is configured to drive the right link arm to extend and retract the right side of the display.

12. The assembly of claim 11, wherein the display tilts toward the left side by approximately 11 degrees when the right link arm extends the right side of the display to an upper limit.

13. The assembly of claim 10, wherein the left link arm moves at a first speed and the right link arm moves at a second speed, and wherein the first speed is approximately twice or one-half of the second speed.

14. The assembly of claim 10, wherein the rail housing comprises a left rail and a right rail, wherein the left link arm moves along the left rail to extend and retract the left side of the display relative to the rail housing, and wherein the right link arm moves along the right rail to extend and retract the right side of the display relative to the rail housing.

15. The assembly of claim 10, wherein the groove comprises an outer edge that is configured to guide a movement of the center arm when the display is around a home position.

16. An assembly for deployment of a display having a first edge and a second edge fitting to a recess region of a structure while at a home position, the assembly comprising:
a rail housing structurally forming a first rail and a second rail;
a first link arm configured to connect to the display; and
a second link arm configured to connect to the display,
wherein the first link arm is driven by at least one motor transmission along the first rail at a first speed and the second link arm is driven by the at least one motor transmission along the second rail at a second speed different from the first speed such that the display does not interfere with the structure during the deployment.

17. The assembly of claim 16, further comprising a center arm configured to attach to the display, wherein the rail housing comprises a groove, and wherein the center arm is configured to move along the groove during the deployment.

18. The assembly of claim 17, wherein the groove comprises an outer edge that is configured to guide a movement of the center arm around the home position.

19. The assembly of claim 18, wherein the display does not tilt toward the first edge nor toward the second edge at the home position, and wherein the display tilts toward the second edge during the deployment.

20. The assembly of claim 19, wherein the first link arm is closer to the first edge and the second link arm is closer to the second edge, and wherein the first speed is approximately twice the second speed.
